(19) United States
(12) Patent Application Publication
(10) Pub. No.: US 2016/0149995 A1
(43) Pub. Date: May 26, 2016

(54) Transfer and synchronization of media data

(71) Applicant: Apple Inc., Cupertino, CA (US)

(72) Inventors: David Heller, San Jose, CA (US); Jeffrey L. Robbin, Los Altos, CA (US); Eddy Cue, Mountain View, CA (US); Christopher R. Wysocki, Los Gatos, CA (US); Steve Jobs, Palo Alto, CA (US)

(21) Appl. No.: 14/950,560

(22) Filed: Nov. 24, 2015

Related U.S. Application Data
(63) Continuation of application No. 11/519,429, filed on Sep. 11, 2006, now abandoned.

(51) Int. Cl. H04L 29/08; H04L 7/00

(52) U.S. Cl. CPC H04L 67/06; H04L 7/0008

(57) ABSTRACT

Improved methods and systems that facilitate transfer and synchronization of data, namely, media data, between a host device (e.g., host computer) and a portable media device (e.g., portable media player) are disclosed. By coupling the portable media device to different host devices at different times, media data can be transferred between the different host devices. Synchronization of media data between a host device and a portable media device can also take into consideration one or more user synchronization related settings.

### CROSS-REFERENCE TO OTHER APPLICATIONS

This application is a continuation of, and claims the benefit of priority to, U.S. application Ser. No. 11/519,429, filed on Sep. 11, 2006, which is expressly incorporated by reference herein in its entirety. Other applications of note are: (i) U.S. application Ser. No. 11/324,863, filed Jan. 3, 2006, and entitled “REMOTE CONTENT UPDATES FOR PORTABLE MEDIA,” which is hereby incorporated herein by reference; (ii) U.S. application Ser. No. 11/097,034, filed Apr. 1, 2005, and entitled “PERSISTENT GROUP OF MEDIA ITEMS FOR A MEDIA DEVICE,” which is hereby incorporated herein by reference; (iii) U.S. application Ser. No. 10/987,649, filed Nov. 12,2004, and entitled “WIRELESS SYNCHRONIZATION BETWEEN MEDIA PLAYER AND HOST DEVICE,” which is hereby incorporated herein by reference; (iv) U.S. application Ser. No. 10/973,657, filed Oct. 25,2004, and entitled “IMAGE SCALING ARRANGEMENT,” which is hereby incorporated herein by reference; (v) U.S. application Ser. No. 10/973,925, filed Oct. 25, 2004, and entitled “MULTIPLE MEDIA TYPE SYNCHRONIZATION BETWEEN HOST COMPUTER AND MEDIA DEVICE,” which is hereby incorporated herein by reference; (vi) U.S. application Ser. No. 10/277,418, filed Oct. 21,2002, and entitled “INTELLIGENT INTERACTION BETWEEN MEDIA PLAYER AND HOST COMPUTER,” which is hereby incorporated herein by reference; and (vii) U.S. application Ser. No. 10/118,069, filed Apr. 5, 2002, and entitled “INTELLIGENT SYNCHRONIZATION OF MEDIA PLAYER WITH HOST COMPUTER,” which is hereby incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure as it appears in the U.S. Patent and Trademark Office patent file or records, but otherwise reserves all copyright rights whatsoever.

### BACKGROUND OF THE INVENTION

1. Field of the Invention

The present invention relates to media devices and, more particularly, to synchronization or management of media on media devices.

2. Description of the Related Art

Synchronization operations have been conventionally performed between portable devices, such as Personal Digital Assistants (PDAs) and host computers, to synchronize electronic files or other resources. For example, these files or other resources can pertain to text files, data files, calendar appointments, emails.to-do lists, electronic rolodexes, etc. However, such synchronization schemes tend to utilize filenames and modification dates to determine whether files need to be copied between the devices.

In the case of media players, such as MP3 players, files are typically moved between a host computer and a media player through use of a drag and drop operation, like is conventionally done with respect to copying of a data file from a Windows desktop to a floppy disk. Hence, the user of the media player manually initiates the synchronization for individual media items. As a consequence, synchronization tends to be tedious and time consuming for users.

More recently, a media player has been able to be synchronized with a host computer when a connector or cable connection is made. In one approach, synchronization can be automatically initiated when a connector or cable provide an electrical connection between the host computer and the media player. The host computer typically executes a media management application, such as iTunes® produced by Apple Computer, Inc. of Cupertino, Calif., to process the synchronization. Media players, such as the iPod® offered by Apple Computer, Inc., have the capability to participate in such synchronization via a connector or a cable.

Memory cards (or USB drives) are often used to store data. Some media players can operate as a memory card and thus provide data storage much like a memory card. The memory cards are very portable and facilitate a user in physically porting data from one computer to another computer. When the memory card is inserted into or attached to a connector or port of a computer, the data storage on the memory card becomes available for use by the computer. A user of the computer can drag and drop or otherwise copy or store data to the memory card connected to the computer. The memory card can then be removed from the computer and carried by the user to another computer where is can be again attached and the data thereon accessible. In general, the transfer of data to and from the memory cards is largely manual.

Thus, there is a continuing need for improved techniques to transfer and synchronize media data on host computers and/or media players.

### SUMMARY OF THE INVENTION

The invention pertains to improved methods and systems that facilitate transfer and synchronization of data, namely, media data, between a host device (e.g., host computer) and a portable media device (e.g., portable media player). By coupling the portable media device to different host devices at different times, media data can be transferred between the different host devices. Synchronization of media data between a host device and a portable media device can also take into consideration one or more user synchronization related settings.

The invention can be implemented in numerous ways, including as a method, system, device, apparatus (including graphical user interface), or computer readable medium. Several embodiments of the invention are discussed below.

As a method for transfer of media data between a host computer and a portable media player, with the host computer providing a media library, one embodiment of the invention includes at least the acts of: determining whether the portable media player has any new media items stored on the portable media player that are not stored in the media library of the host computer; determining whether the new media items stored on the portable media player are to be transferred to the media library of the host computer; and transferring the new media items from the portable media player to the media library on the host computer when it is determined that the new media items stored on the portable media player are to be transferred to the media library of the host computer.

As a computer readable medium including at least computer program code for transfer of media data between a host computer and a portable media player, with the host computer providing a media library, one embodiment of the invention includes at least: computer program code for determining whether the portable media player has any new media items stored on the portable media player that are not stored in the media library of the host computer; computer program code for determining whether the new media items stored on the portable media player are permitted to be transferred to the media library of the host computer; and computer program code for transferring the new media items from the portable media player to the media library on the host computer when it is determined that the new media items stored on the portable media player are permitted to be transferred to the media library of the host computer.

As a method for synchronizing media items between a host computer and a portable media player, one embodiment of the invention includes at least the acts of: retrieving synchronization preferences for a plurality of different media types; determining, for each of the plurality of different media types, media items of the particular media type to be copied from the host computer to the portable media player based on the synchronization preference corresponding to the particular media type; and copying the determined media items from the host computer to the portable media player.

As a computer readable medium including at least computer program code for synchronizing media items between a host computer and a portable media player, one embodiment of the invention includes at least: computer program code for retrieving a first synchronization preference for a first media type and a second synchronization preference for a second media type; computer program code for determining media items of the first media type to be copied from the host computer to the portable media player based on the first synchronization preference; computer program code for determining media items of the second media type to be copied from the host computer to the portable media player based on the second synchronization preference; and computer program code for copying the determined media items of the first media type and the second media type from the host computer to the portable media player.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of a media distribution system according to one embodiment of the invention.

FIG. 2 is a flow diagram of a media transfer and synchronization process according to one embodiment of the invention.

FIGS. 3A-3C are flow diagrams of a media transfer and synchronization process according to another embodiment of the invention.

FIG. 4 is a representative screen illustration according to one embodiment of the invention.

FIGS. 5A and 5B are flow diagrams of a multimedia synchronization process according to one embodiment of the invention.

FIGS. 6A-6C are screen shots indicating synchronization preference settings for TV shows, movies and podcasts, respectively.

FIG. 7 is a block diagram of a media management system according to one embodiment of the invention.

FIG. 8 is a block diagram of a media player suitable for use with the invention.

### DETAILED DESCRIPTION OF THE INVENTION

The invention pertains to improved methods and systems that facilitate transfer and synchronization of data, namely, media data, between a host device (e.g., host computer) and a portable media device (e.g., portable media player). By coupling the portable media device to different host devices at different times, media data can be transferred between the different host devices. Synchronization of media data between a host device and a portable media device can also take into consideration one or more user synchronization related settings. Other aspects and features of the invention will become apparent below.

“Media items,” as used herein, is digital data that pertains to at least one of audio, video, and images. The digital data for media items can be referred to as media data or media content. Some examples of specific forms of media items include, but are not limited to, songs, albums, audiobooks, playlists, movies, music videos, photos, computer games, podcasts, audio and/or video presentations, news reports, and sports updates.

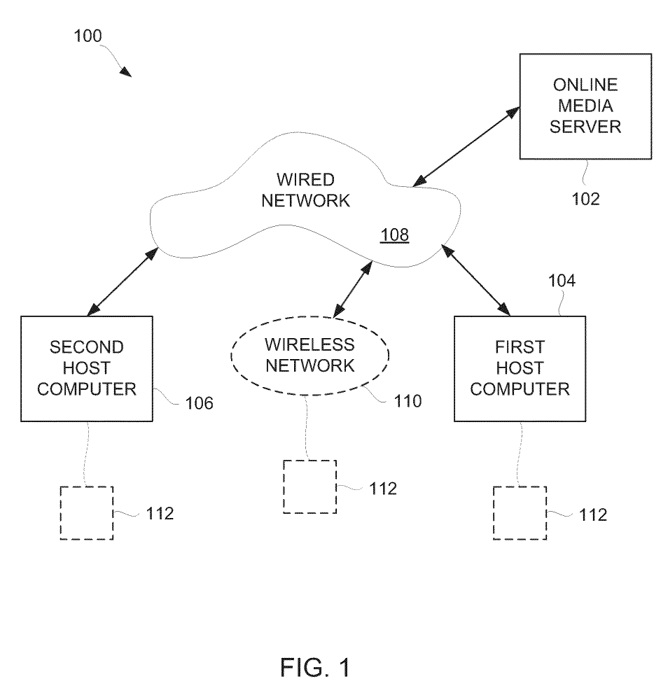

Embodiments of the invention are discussed below with reference to FIGS. 1-8. However, those skilled in the art will readily appreciate that the detailed description given herein with respect to these figures is for explanatory purposes as the invention extends beyond these limited embodiments.

One aspect of the invention pertains to transfer and synchronization of media data between a host computer and a portable media device. Advantageously, a portable media device is able to receive and store media data from a first host computer and then subsequently provide the media data to a second host computer. The portable media device can thus be used to transfer media data from one host computer to another. In one embodiment, the transfer of media data can be restricted to certain qualifying devices and/or qualifying media data. In one implementation, the transfer of media data between devices can be performed together or independent of a synchronization of media data between the devices.

FIG. 1 is a block diagram of a media distribution system 100 according to one embodiment of the invention. The media distribution system 100 includes an online media server 102. The online media server 102 hosts an online media store. A first host computer 104 and a second host computer 106 can interact with the online media store operating on the online media server 102 via a wired network 108. The media distribution system 100 can also include a wireless network 110. One or more of the first host computer 104, the second host computer 106 and the wireless network 110 can support a portable media device 112 (e.g., a portable media player). In other words, the portable media device 112 can be coupled to the first host computer 104, the second host computer 106 or the wireless network 110. When the portable media player 112 is connected to the first host computer 104, the portable media device 112 can be synchronized with a host media library residing on the first host computer 104. Likewise, when the portable media device 112 is coupled to the second host computer 106, the portable media device 112 can be synchronized with a host media library residing on the second host computer 106. In one embodiment, the portable media device 112 can be synchronized with the host media library residing on either the first host computer or the second host computer, but not both at the same time. The host media libraries can include various media items. Some of the media items in the host media libraries can be acquired from the online media store. For example, a user of the first host computer 104 can interact with the online media stored operated by the online media server 102 to search or browse media items and then acquire (e.g., buy, license or lease) one or more media items, whereby the acquired one or more media items are then downloaded to the first host computer 104. Subsequently, when the portable media device 112 is coupled to the first host computer 104, the acquired one or more items can be copied from the first host computer 104 to the portable electronic device 112. The first host computer 104, and thus the portable media device 112 if coupled thereto, can alternatively receive media items from other media sources, such as Compact Discs (CDs), memory cards, other host computers, or other media devices.

The portable media device 112 can also facilitate transfer of media items from one host computer to another host computer. For example, the portable media device 112 when coupled to the first host computer 104 can receive and store one or more media items that are copied from the first host computer 104. These one or more media items, in one embodiment, are media items that were acquired from the online media store to the first host computer 104. Although the media source can be the online media store, other media sources can also be used. However, in one embodiment, media items acquired from an online media store (e.g., purchased media items) can include an indicator that indicates whether they were purchased from the online media store. In addition, a unique identifier can be provided for each media item so that at least as compared to all the content on the online media store, the media items are known. The indicators for online media stores and the unique identifiers can be merged together or remain separate values. In any case, after the portable media device 112 receives and stores the one or more media items, the portable media device 112 is decoupled from the first host computer 104 and subsequently eventually coupled to the second host computer 106. At this point, the second host computer 106 may not have the one or more media items that are stored on the portable media device 112. Hence, these one or more media items on the portable media device 112 can be transferred from the portable media device 112 to the second host computer 106. The transfer of these one or more media files can be done automatically (e.g., in accordance with a preference setting) and/or upon user request. In one embodiment, the transfer of the one or media files can be limited. For example, in order to transfer the one or more media items to the second host computer 106, the second host computer 106 must be authorized to be permitted to play the one or more media items. Also, in one embodiment, the transfer of media items can be restricted such that only those media items that are acquired from the online media store are permitted to be transferred. Additional details on the transfer of media files between portable media devices and host computers are provided below.

The portable media device 112 could, in some embodiments, also couple to the wireless network 110. In such case, using the wireless network 110, the portable media device 112 could couple to any of the online server 102, the first host computer 104, the second host computer 106, or other host computer or server. As a result, one or more media items stored on the portable media device 112 could be transferred from the portable media device 112 to some other device (e.g., computing device or storage unit) via the wireless network 110.

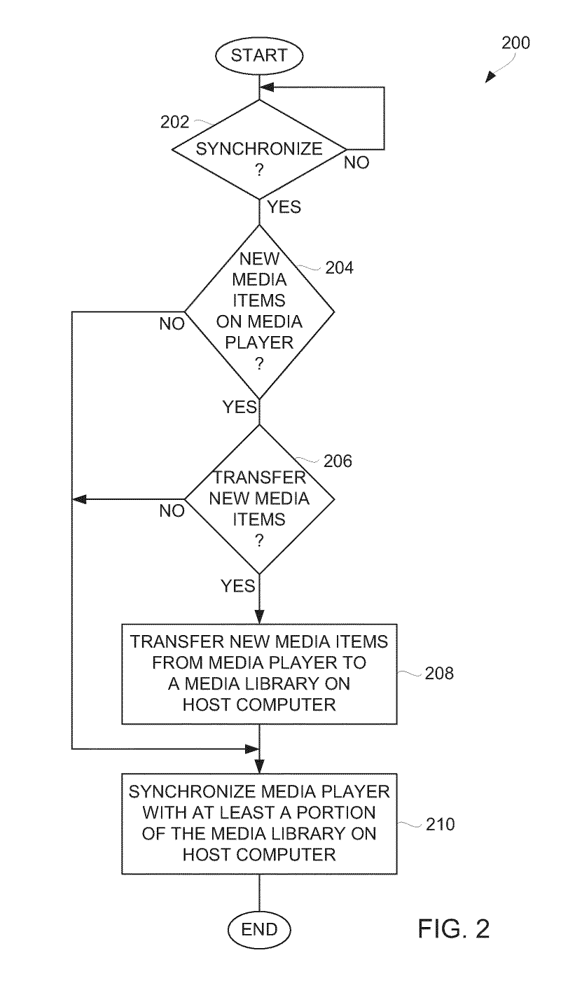

FIG. 2 is a flow diagram of a media transfer and synchronization process 200 according to one embodiment of the invention. The media transfer and synchronization process 200 is, for example, performed by a host computer that is capable of having a media player coupled thereto. For example, the host computer can pertain to the first host computer 104 or the second host computer 106 and the media player can pertain to the portable media device 112 illustrated in FIG. 1.

The media transfer and synchronization process 200 begins with a decision 202 that determines whether synchronization is to be performed. When the decision 202 determines that synchronization is not to be performed, the media transfer and synchronization process 200 awaits the need for synchronization. On the other hand, once the decision 202 determines that synchronization is to be performed, the media transfer and synchronization process 200 continues. In effect, the media transfer and synchronization process 200 actively begins when synchronization has been requested, either manually through user request or automatically by a detected event. One example of a detected event is a media player coupling to a host computer.

When the decision 202 determines that synchronization is to be performed, a decision 204 determines whether there are any new media items on the media player. The media player is, for example, the portable media device 112 illustrated in FIG. 1. The determination of whether there are new media items on the media player can be performed in a variety of different ways depending on implementation. In one implementation, any media items on the portable media device that are not already on the host computer can be considered new media items. In another implementation, only media items purchased from an authorized online media store can be considered new media items. In another implementation, only certain types of media items are considered as candidates for being new media items.

In any case, when the decision 204 determines that there are new media items on the media player, a decision 206 determines whether the new media items are to be transferred. The decision 206 on whether the new media items are to be transferred can be resolved automatically or through user input. For example, user preferences or program design can cause new media items to be automatically transferred or automatically excluded from transfer. Also, user input can be solicited to decide case by case whether particular new media items are to be transferred. Additionally, the decision 206 on whether the new media items are to be transferred can also be dependent on the characteristics (e.g., size, age, date, origin, type) of the media items. In one embodiment, only new media items that have been purchased from the online media store are eligible for transfer.

When the decision 206 determines that the new media items are to be transferred, the new media items are transferred 208 from the media player to a media library on the host computer. It is assumed that the media player is already coupled (wired or wirelessly) with the host computer. Next, the media player can be synchronized 210 with at least a portion of the media library on the host computer. Accordingly, prior to synchronizing the media player with the host computer, any new media items stored on the media player can first be transferred to the host computer. As a result, the media player is, in effect, transporting new media items that have been previously acquired from another media source and subsequently providing them to the host computer that is coupled to the host computer. Following the block 210, the media transfer and synchronization process 200 ends.

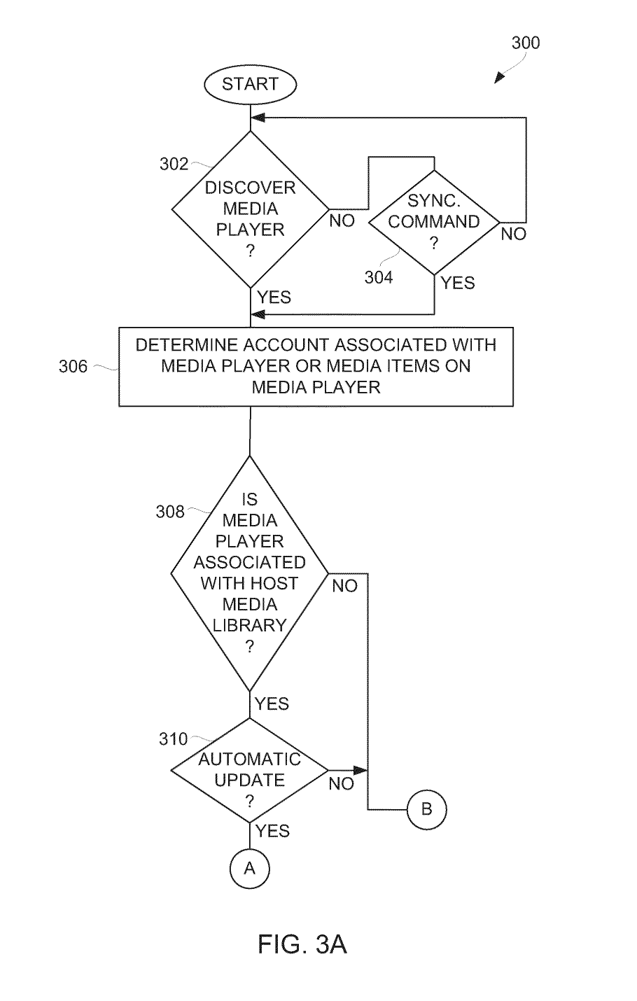

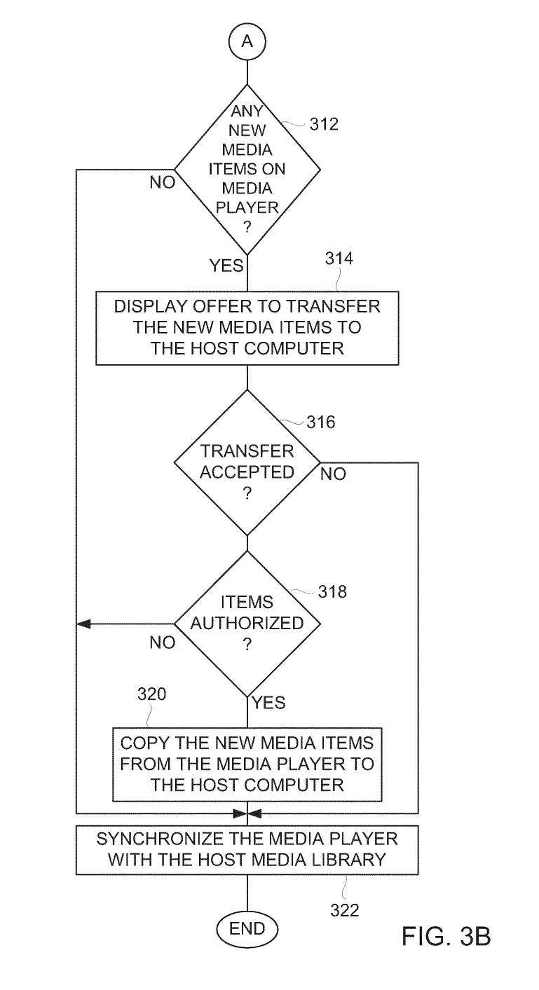

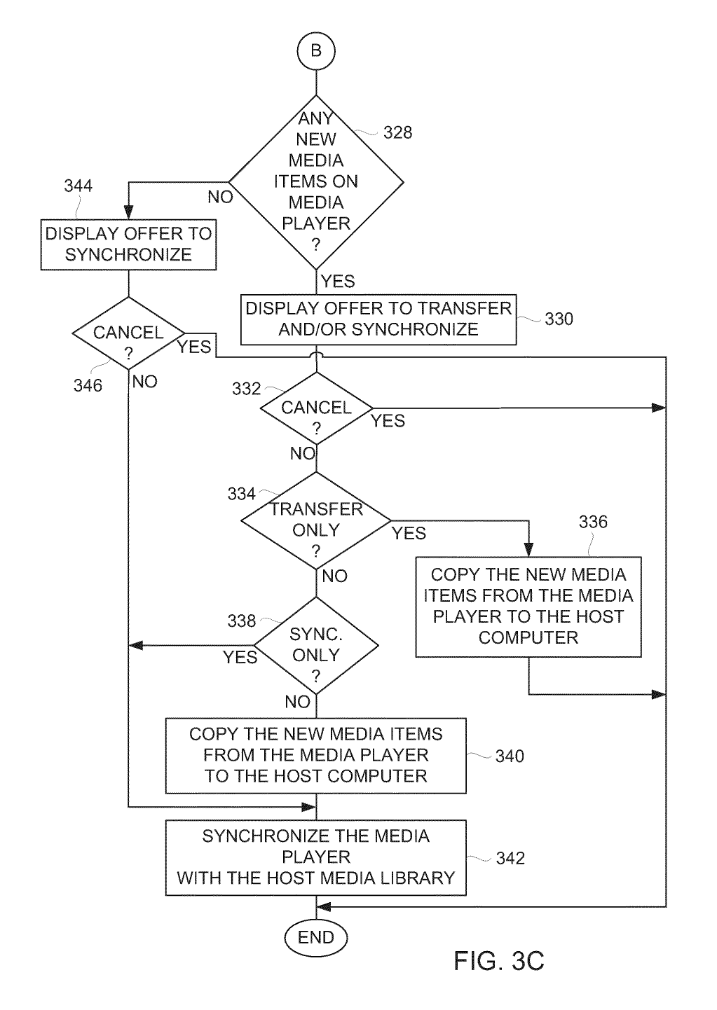

FIGS. 3A-3C are flow diagrams of a media transfer and synchronization process 300 according to another embodiment of the invention. The media transfer and synchronization process 300 is, for example, performed by a host computer that is capable of having a media player coupled thereto. For example, the host computer can pertain to the first host computer 104 or the second host computer 106 and the media player can pertain to the portable media device 112 illustrated in FIG. 1.

The media transfer and synchronization process 300 begins with a decision 302 that determines whether a media player has been discovered. For example, discovery of a media player can occur when the media player couples to the host computer. The coupling can be over a wired connection (e.g., via cable or connector) or a wireless connection (e.g., short range wireless, such as Bluetooth). When the decision 302 determines that the media player has not been discovered, a decision 304 determines whether a user has entered a synchronization command. The synchronization command can be entered by way of a menu selection, button (physical or virtual), or the like. When the decision 304 determines that a synchronization command has not been made, the media transfer and synchronization process 300 returns to repeat the decision 302 and subsequent blocks. Alternatively, either when the decision 302 determines that a media player has been discovered or when the decision 304 determines that a synchronization command has been received, the media transfer and synchronization process 300 continues.

When the media transfer and synchronization process 300 continues, an account associated with the media player or with media items stored on the media player is determined 306. In one embodiment, the media player and the host computer store an indication of an account for which they are associated. In the same or another embodiment, some media items can contain an indication of an account or otherwise associate with an account. In one embodiment, an account can pertain to a user account of an online media store.

Next, a decision 308 determines whether the media player is associated with a host media library resident on the host computer. Here, in this embodiment, it is assumed that the media player can be associated with only a single host media library resident on a particular host computer. When the decision 308 determines that the media player is associated with the host media library resident on the host computer, a decision 310 determines whether an automatic update should be performed.

When the decision 310 determines that an automatic update should be performed, a decision 312 determines whether there are any new media items on the media player. When the decision 312 determines that there are new media items on the media player, an offer to transfer the new media items to the host computer can be displayed 314. Thereafter, a decision 316 determines whether the offer to transfer has been accepted by the user of the host computer. When the decision 316 determines that the offer to transfer has been accepted, a decision 318 determines whether the new media items are authorized to be used (e.g., played) by the host computer. If the decision 318 determines that the new media items are authorized to be used by the host computer, the new media items are copied 320 from the media player to the host computer. Alternatively, when the decision 314 determines that the offer to transfer has been declined, the block 320 is bypassed such that the new media items are not copied from the media player to the host computer. Also, when the decision 318 determines that the media items are not authorized, the block 320 can also be bypassed. In one embodiment, if some of the media items are authorized and some are not, those of the media items that are authorized can be copied 320. Optionally, the user could be prompted to provide authorization in the event that the media items are not authorized. Alternatively, when the decision 312 determines that there are no new media items on the media player, then the blocks 314-320 can be bypassed.

Following the block 320 or its being bypassed, the media player can then be synchronized 322 with the host media library. Typically, the synchronization 322 of the media player with the host media library involves copying of one or more media items from the host media library to the media player. The extent to which the media items from the host media library are copied to the media player can vary depending upon user input, user preferences, available storage capacity, size, date, transfer speed, etc. Following the block 322, the media transfer and synchronization process 300 ends.

In an alternative embodiment, the blocks 314 and 316 could be replaced by other blocks that avoid the need for user interaction to accept an offer to transfer. In such an embodiment, instead of displaying an offer to transfer, the media transfer and synchronization process would access one or more appropriate synchronization preference(s) for the account and then determine whether from the synchronization preference(s) whether new media files are to be copied from the media player to the host computer prior to synchronization. As such, the transfer of the new media items could be automatically declined or performed based on the synchronization preference(s). An advantage of using a user preference in this manner would be that less user interaction would be required to implement the media transfer and synchronization process.

Alternative processing can be performed either when the media player is not associated with the host media library or when the automatic updating is not requested (i.e., disabled by user preference setting). In such case, the processing illustrated in FIG. 3C is performed. Here, a decision 328 determines whether any new media items are present on the media player. When the decision 328 determines that there are new media items on the media player, an offer to transfer and/or synchronize the media items is displayed 330. Here, the offer to transfer and/or synchronize would typically be displayed on the display device associated with the host computer. Next, a decision 332 determines whether the user has elected to cancel the media transfer and synchronization process 300 in response to the offer to transfer and/or synchronize. When the decision 332 determines that the user has not elected to cancel the media transfer and synchronization process 300, a decision 334 determines whether the user has elected to only transfer the media data and not to provide synchronization in response to the offer to transfer and/or synchronize. In such case, the new media items are copied 336 from the media player to the host computer. Alternatively, when the decision 334 determines that the response to the offer to transfer and/or synchronize is not requesting to only transfer the media data without synchronization, a decision 338 determines whether only synchronization is to be performed. When the decision 338 determines that both transfer and synchronization are to be performed, then the new media items are copied 340 from the media player to the host computer. Thereafter, the media player is synchronized 342 with the host media library. On the other hand, when the decision 338 determines that only synchronization is to be performed, then block 340 is bypassed and the media player is then synchronized 342 with the host media library. Following the block 342 or the block 336 as well as following the decision 332 when the media transfer and synchronization process 300 is to be canceled, the media transfer and synchronization process 300 ends.

On the other hand, when the decision 328 determines that there are no new media items on the media player, then an offer to synchronize can be displayed 344. In response to the offer to synchronize, a decision 346 determines whether the response to the offer synchronize is to cancel the media transfer and synchronization process 300. When the decision 346 determines that the media transfer and synchronization process 300 is to be canceled, then the media transfer and synchronization process 300 ends. Alternatively, when the response to the offer to synchronize indicates that synchronization should be performed (i.e., not be canceled), the media transfer and synchronization process 300 can then synchronize 342 the media player with the host media library so that the media player is synchronized with the host media library.

The determination of whether there are new media items on the media player at blocks 318 and 328 can be performed in a variety of different ways depending on implementation. In one implementation, any media items on the portable media device that are not already on the host computer can be considered new media items. In another implementation, only media items purchased from an authorized online media store can be considered new media items. In another implementation, only certain types of media items are considered as candidates for being new media items. As noted above, after the new media items are identified, the new media items may be transferred to a host computer (blocks 324, 336 and 340). However, the eXtent to which the new media items are transferred can be restricted. User preference settings, media item restrictions (e.g., digital rights limits), and/or programmed limitations can be used to restrict those of the new media items that are eligible or permitted to be transferred. Additionally, deciding whether media items are new media items and/or deciding whether the new media items are to be transferred can also be dependent on the characteristics (e.g., size, age, date, origin, type) of the media items. In one embodiment, only new media items that have been purchased from the online media store are eligible for transfer.

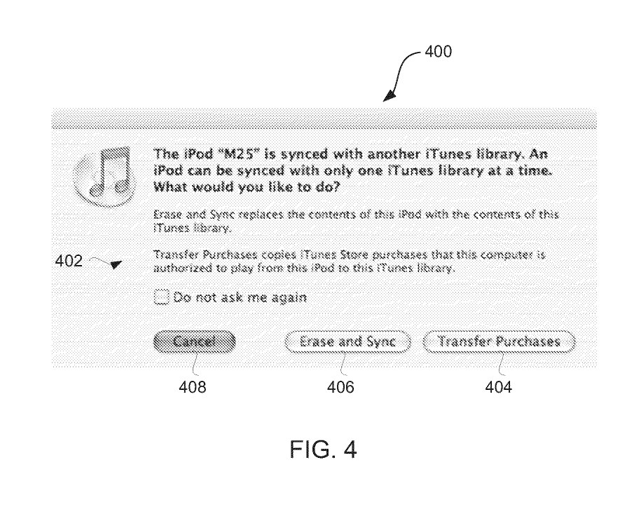

FIG. 4 is a representative screen illustration 400 according to one embodiment of the invention. The representative screen illustration 400 is, for example, a dialog screen that can be displayed on a display device associated with the host computer. The representative screen illustration 400 can, for example, pertain to the offer to transfer and/or synchronize that is displayed at block 330 of the media transfer and synchronization process 300 illustrated in FIG. 3C. The representative screen illustration 400 provides information 402 concerning synchronization and transfer of purchased media. In this embodiment, the media items being offered for transfer are only those media items that have been purchased from an online music store (e.g., iTunes® Store). The information 402 also notes that for the transfer to be performed, the recipient computer needs to be authorized to play the media items. Further, in this embodiment, the media player was determined not to be associated with the host media library (e.g., iTunes® Library); hence, the information 402 further explains that the media player (e.g., iPod®) can be synchronized only with one host media library (e.g., iTunes® Library). The representative screen illustration 400 provides user controls (or user interface controls) that can be selected by the user of the host computer. More particularly, the user controls can pertain to virtual buttons presented on a display screen and being available for selection. The representative screen illustration 400 includes a “Transfer Purchases” user control 404, an “Erase and Sync” user control 406, and a “Cancel” user control 408. Processing performed by a media transfer and/or synchronization process can be determined based on the selection of the one of the user interface controls 404-408.

Another aspect of the invention pertains to synchronization of media items between a media player and a host computer. More particularly, user preference settings are available to guide synchronization with respect to multiple types of media items.

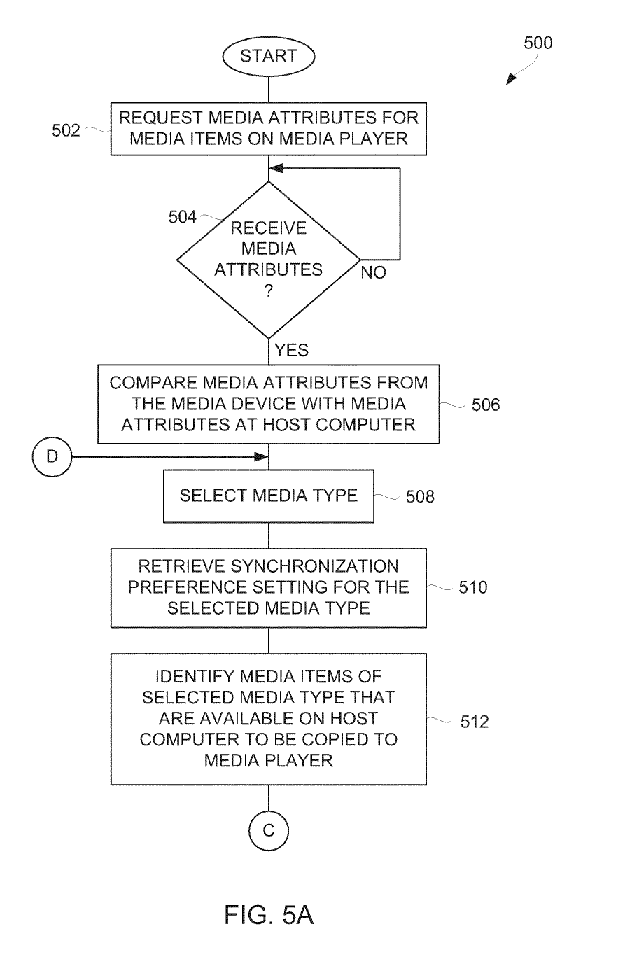

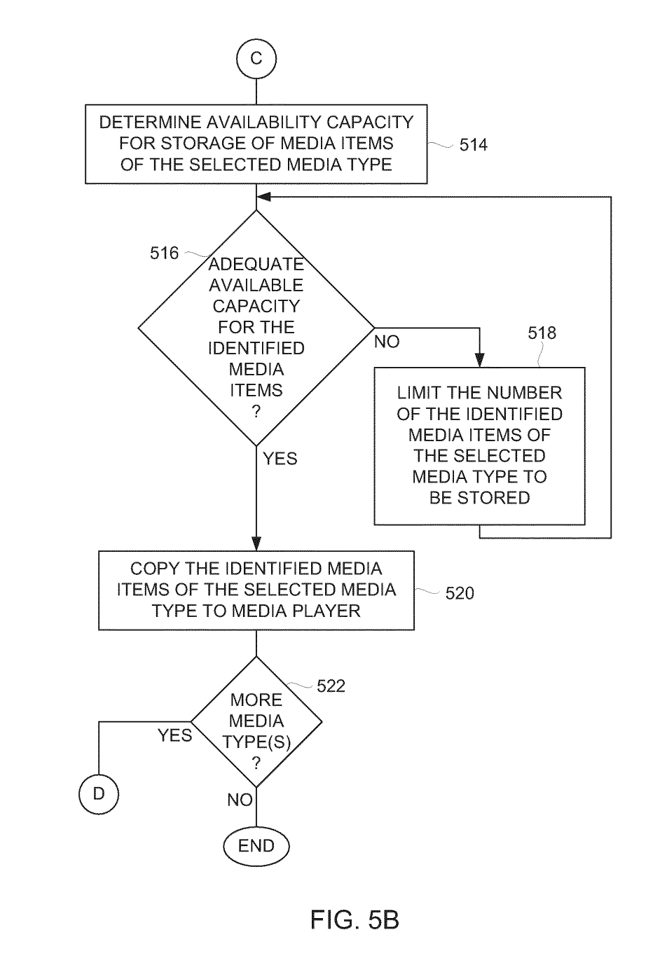

FIGS. 5A and 5B are flow diagrams of a multimedia synchronization process 500 according to one embodiment of the invention. The multimedia synchronization process 500 is, for example, performed by a host computer. For example, the host computer can pertain to the first host computer 104 or the second host computer 106 illustrated in FIG. 1.

The multimedia synchronization process 500 can be performed independent of the media transfer and synchronization process 200 or the media transfer and synchronization process 300. Alternatively, the multimedia synchronization process 500 could be performed at block 210 of FIG. 2 of the media transfer and synchronization process 200, or be performed at block 326 of FIG. 3B or block 342 of FIG. 3C of the media transfer and synchronization process 300.

The multimedia synchronization process 500 initially requests 502 media attributes for media items on the media player. Then, a decision 504 determines whether the media attributes have been received from the media player. When the decision 504 determines that the media attributes have not been received, the multimedia synchronization process 500 can await the receipt of the media attributes. Once the decision 504 determines that the media attributes have been received, the media attributes from the media device are compared 506 with media attributes for media items on the host computer. The comparison 506 operates to identify those media items residing on the host computer that are already residing on the media player. As such, the host computer understands which of its media data is already located on the media player and which media data is to be transferred to the media player.

The media player and the host computer typically support multiple different types of media items. The different types of media items can be grouped into categories. For example, in one implementation, the different types of media can be grouped into audio, video and other categories. Such categories can also be considered media types. The synchronization of these different types of media items can be separately performed for the different media types (including groupings into categories) so that different synchronization processing can be utilized for the different media types. Hence, as in such an example, movies could be governed by a video synchronization preference setting.

In this regard, a media type is selected 508. Here, the media type being selected 508 is one of the media types (including groupings into categories) that are utilized on the host computer. In other words, the host computer stores media items of the selected media type. Next, a synchronization preference setting for the selected media type is retrieved 510. For example, if the media type is movies, the synchronization preference setting could be a synchronization preference setting specifically associated with movies. Alternatively, the synchronization preference setting could be general so as to apply to a group or category of one or more different types. Examples of such groups or categories include audio, video or other data.

In any case, after the synchronization preference setting has been retrieved 510, media items of the selected media type that are available on the host computer to be copied to the media player are identified 512. Typically, the identified media items are also those media items of the selected media type that satisfy the synchronization preference setting. Next, available capacity for storage of media items of the selected media type is determined 514. A decision 516 then determines whether there is adequate available capacity on the media player for the identified media items. When the decision 516 determines that the available capacity is inadequate, the number of identified media items of the selected media type to be stored is limited 518. By limiting the number of identified media items of the selected media items that are to be stored, the quantity of data to be stored is reduced so as to not exceed the available capacity. The available capacity can be a hardware limitation or a software allocation. The available capacity can also be configured to set limits on the amount of storage capacity to be allocated to storage of different types of media items (including different groupings of types of media items). Following the block 518, the multimedia synchronization process 500 returns to repeat the decision 516 so that the available capacity can be again ascertained.

Once the decision 516 determines that the available capacity for the identified media items is adequate on the media player, the identified media items of the selected media type are copied 520 to the media player. Thereafter, a decision 522 determines whether there are more media types to be processed. When the decision 522 determines that there are more media types to be processed, the multimedia synchronization process 500 returns to repeat the block 508 and subsequent blocks so that another media type can be selected and similarly processed. Alternatively, when the decision 522 determines that there are no more media types to be processed, the multimedia synchronization process 500 ends.

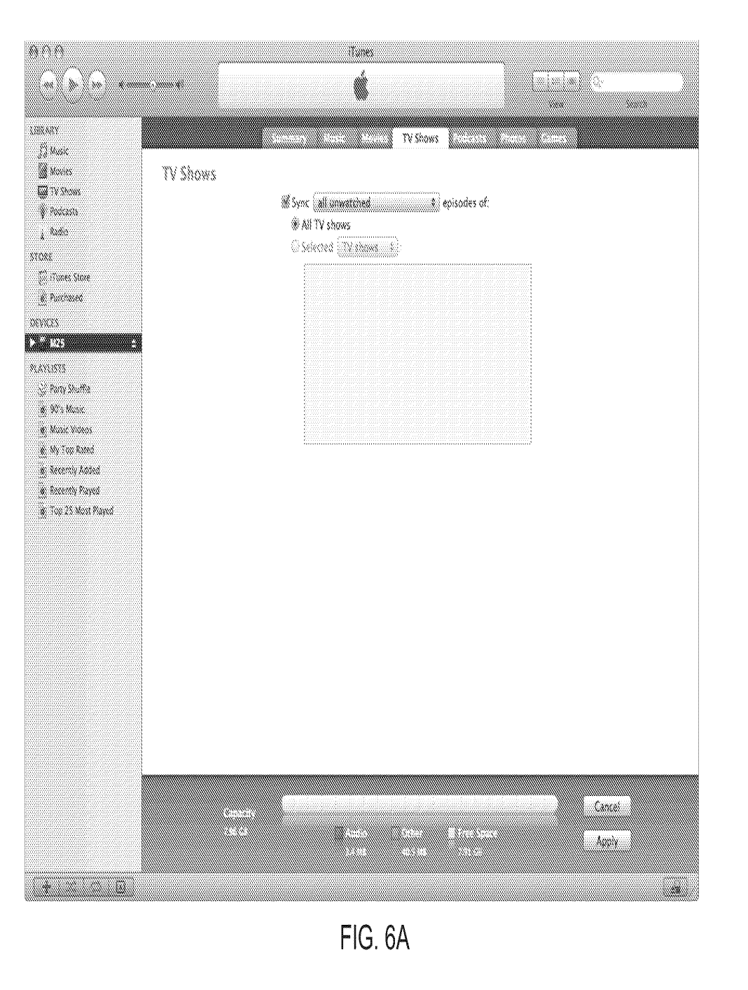

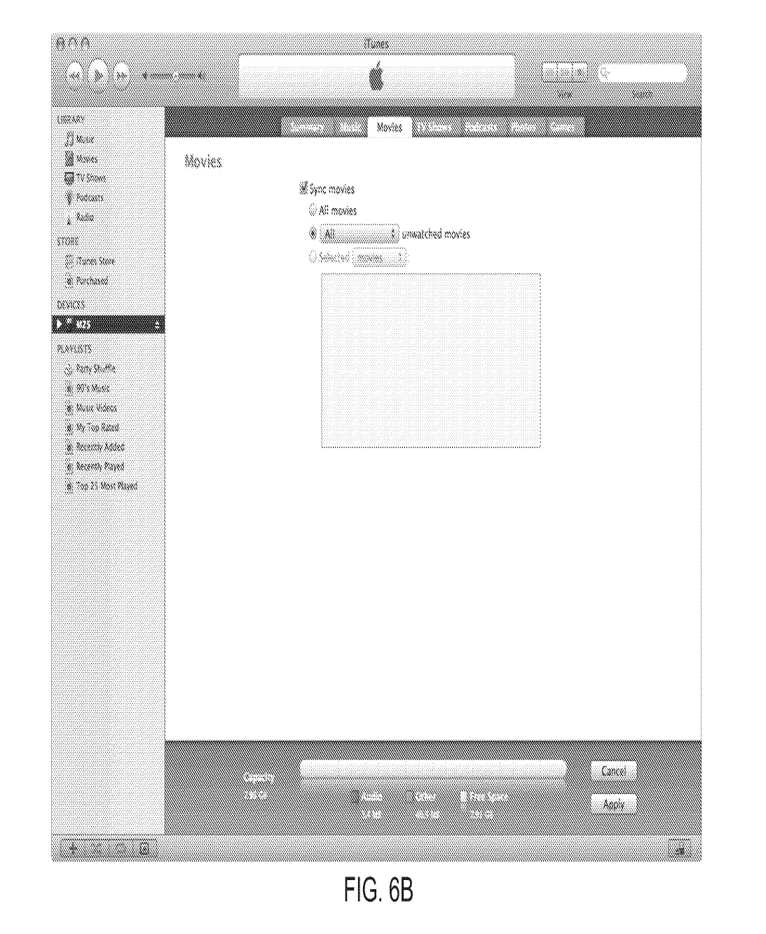

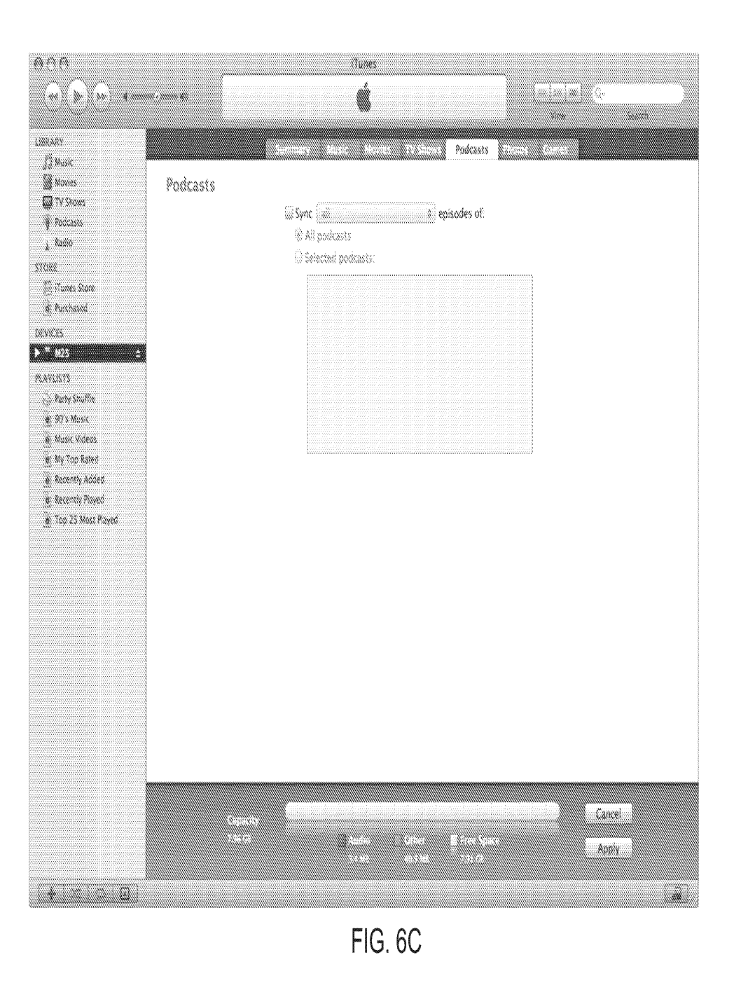

FIGS. 6A-6C are screen shots indicating synchronization preference settings for TV shows, movies and podcasts, respectively. These different types of media items are thus able to set synchronization preferences separately. A user is able to interact with the host computer, namely, a media management application operating on the host computer, to set synchronization preferences (synchronizations settings). These synchronization preferences are used in determining which media items are to be copied to the media player during synchronization (e.g., block 510 of FIG. 5A). In FIG. 6A, the synchronization preferences for TV shows can indicate that all or a limited number of unwatched episodes of all or selected TV shows are to be synchronized. Alternatively, all or a limited number of recent episodes of all or selected TV shows can be designated for synchronization. In FIG. 6B, the synchronization preferences for movies can be set. Here, movies can be synchronized in a variety of different ways. For example, all movies, all unwatched movies, a limited number of recent unwatched movies, or only selected movies can be synchronized. In FIG. 6C, synchronization preferences for pod casts can be set. As illustrated, pod casts can be designated for synchronization such that all or a limited number of unplayed episodes of all podcasts or selected pod casts can be designated for synchronization. Alternatively, all or a limited number of recent episodes of all podcasts or selected podcasts can be designated for synchronization.

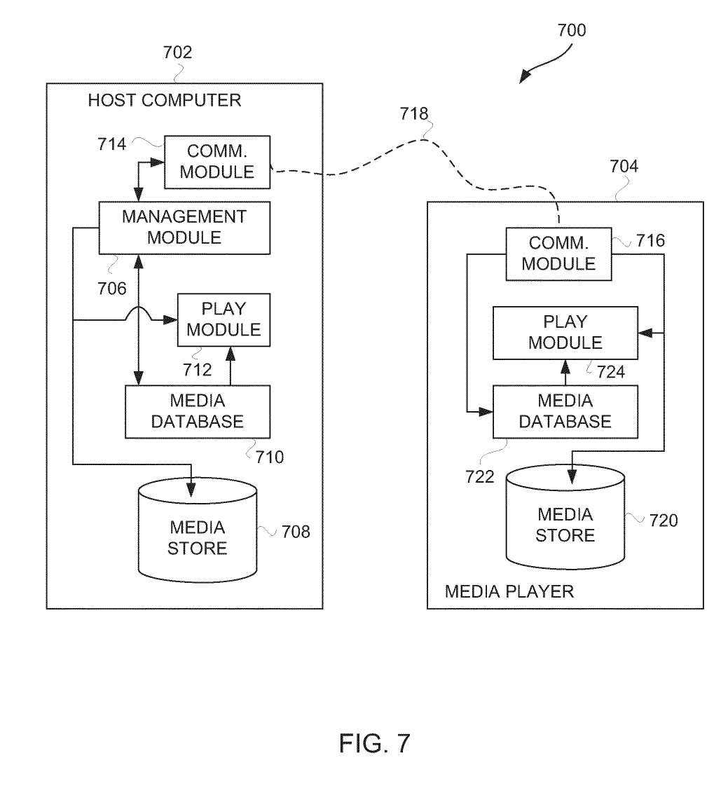

FIG. 7 is a block diagram of a media management system 700 according to one embodiment of the invention. The media management system 700 includes a host computer 702 and a media player 704. The host computer 702 is typically a personal computer. The host computer, among other conventional components, includes a management module 706 which is a software module. The management module 706 provides for centralized management of media items (and/or playlists) not only on the host computer 702 but also on the media player 704. More particularly, the management module 706 manages those media items stored in a media storage device 708 associated with the host computer 702. The management module 706 also interacts with a media database 710 to store media information associated with the media items stored in the media storage device 708. In managing the media items at the host computer 702, the management module 706 can perform transfer and/or synchronization of media items.

The media information pertains to characteristics or attributes of the media items. For example, in the case of audio or audiovisual media, the media information can include one or more of: title, album, track, artist, show, series, actors, directors, producers, composer and genre. These types of media information are specific to particular media items. In addition, the media information can pertain to quality characteristics of the media items. Examples of quality characteristics of media items can include one or more of: bit rate, sample rate, resolution, equalizer setting, volume adjustment, start/stop and total time.

Still further, the host computer 702 includes a play module 712. The play module 712 is a software module that can be utilized to play certain media items stored in the media storage device 708. The play module 712 can also display (on a display screen) or otherwise utilize media information from the media database 710. Typically, the media information of interest corresponds to the media items to be played by the play module 712.

The host computer 702 also includes a communication module 714 that couples to a corresponding communication module 716 within the media player 704. A connection or link 718 removeably couples the communication modules 714 and 716. In one embodiment, the connection or link 718 is a cable that provides a data bus, such as a FIREWIRE™ bus or USB bus, which is well known in the art. In another embodiment, the connection or link 718 is a wireless channel or connection through a wireless network. Hence, depending on implementation, the communication modules 714 and 716 may communicate in a wired or wireless manner.

The media player 704 also includes a media store 720 that stores media items within the media player 704. Optionally, the media store 720 can also store data, i.e., non-media item storage. The media items being stored to the media store 720 are typically received over the connection or link 718 from the host computer 702. More particularly, the management module 706 sends all or certain of those media items residing on the media storage device 708 over the connection or link 718 to the media store 720 within the media player 704. Additionally, the corresponding media information for the media items that is also delivered to the media player 704 from the host computer 702 can be stored in a media database 722. In this regard, certain media information from the media database 710 within the host computer 702 can be sent to the media database 722 within the media player 704 over the connection or link 718. Still further, playlists identifying certain of the media items can also be sent by the management module 706 over the connection or link 718 to the media store 720 or the media database 722 within the media player 704.

Furthermore, the media player 704 includes a play module 724 that couples to the media store 720 and the media database 722. The play module 724 is a software module that can be utilized to play certain media items stored in the media store 720. The play module 724 can also display (on a display screen) or otherwise utilize media information from the media database 722. Typically, the media information of interest corresponds to the media items to be played by the play module 724.

Hence, in one embodiment, the media player 704 has limited or no capability to manage media items on the media player 704. However, the management module 706 within the host computer 702 can indirectly manage the media items residing on the media player 704. For example, to “add” a media item to the media player 704, the management module 706 serves to identify the media item to be added to the media player 704 from the media storage device 708 and then causes the identified media item to be delivered to the media player 704. As another example, to “delete” a media item from the media player 704, the management module 706 serves to identify the media item to be deleted from the media storage device 708 and then causes the identified media item to be deleted from the media player 704. As still another example, if changes (i.e., alterations) to characteristics of a media item were made at the host computer 702 using the management module 706, then such characteristics can also be carried over to the corresponding media item on the media player 704. In one implementation, the additions, deletions and/or changes occur in a batch-like process during synchronization of the media items on the media player 704 with the media items on the host computer 702.

In another embodiment, the media player 704 has limited or no capability to manage playlists on the media player 704. However, the management module 706 within the host computer 702 through management of the playlists residing on the host computer can indirectly manage the playlists residing on the media player 704. In this regard, additions, deletions or changes to playlists can be performed on the host computer 702 and then be carried over to the media player 704 when delivered thereto.

As previously noted, synchronization is a form of media management. The ability to automatically initiate synchronization was also previously discussed above and in the related application noted above. Still further, however, the synchronization between devices can be restricted so as to prevent automatic synchronization when the host computer and media player do not recognize one another.

According to one embodiment, when a media player is first connected to a host computer (or even more generally when matching identifiers are not present), the user of the media player is queried as to whether the user desires to affiliate, associate, assign or lock the media player to the host computer. When the user of the media player elects to affiliate, assign or lock the media player with the host computer, then a pseudo-random identifier is obtained and stored in either the media database or a file within both the host computer and the media player. In one implementation, the identifier is an identifier associated with (e.g., known or generated by) the host computer or its management module and such identifier is sent to and stored in the media player. In another implementation, the identifier is associated with (e.g., known or generated by) the media player and is sent to and stored in a file or media database of the host computer.

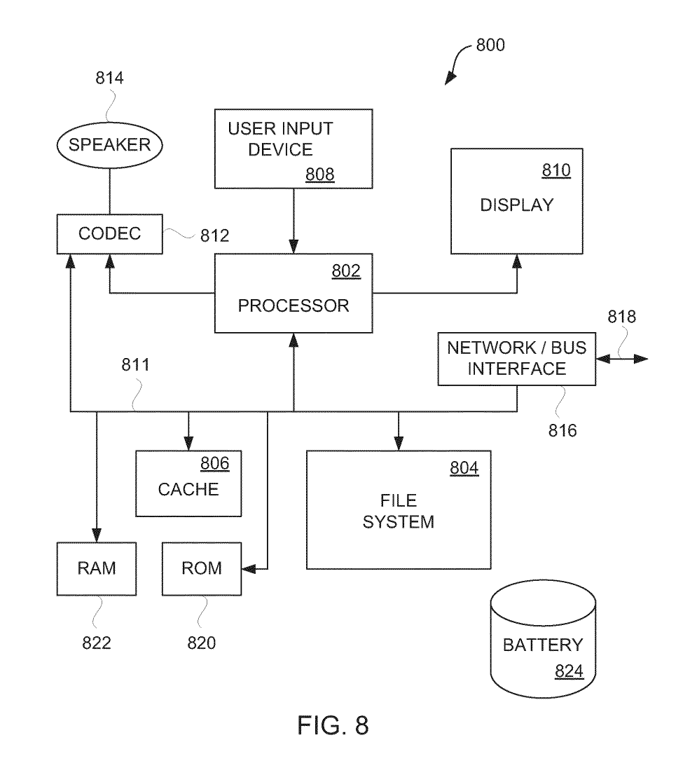

FIG. 8 is a block diagram of a media player 800 suitable for use with the invention. The media player 800 illustrates circuitry of a representative portable media device.

The media player 800 includes a processor 802 that pertains to a microprocessor or controller for controlling the overall operation of the media player 800. The media player 800 stores media data pertaining to media items in a file system 804 and a cache 806. The file system 804 is, typically, semiconductor memory (e.g., Flash memory) or one or more storage disks. The file system 804 typically provides high capacity storage capability for the media player 800. However, since the access time to the file system 804 can be relatively slow, the media player 800 can also include the cache 806. The cache 806 is, for example, Random-Access Memory (RAM) provided by semiconductor memory. The relative access time to the cache 806 is typically shorter than for the file system 804. However, the cache 806 does not have the large storage capacity of the file system 804. Further, the file system 804, when active, consumes more power than does the cache 806. The power consumption is often a concern when the media player 800 is a portable media player that is powered by a battery 824. The media player 800 also includes a RAM 820 and a Read-Only Memory (ROM) 822. The ROM 822 can store programs, utilities or processes to be executed in a non-volatile manner. The RAM 820 provides volatile data storage, such as for the cache 806.

The media player 800 also includes a user input device 808 that allows a user of the media player 800 to interact with the media player 800. For example, the user input device 808 can take a variety of forms, such as a button, keypad, dial, touch-sensitive surface, etc. Still further, the media player 800 includes a display 810 (screen display) that can be controlled by the processor 802 to display information to the user. A data bus 811 can facilitate data transfer between at least the file system 804, the cache 806, the processor 802, and the CODEC 812.

In one embodiment, the media player 800 serves to store a plurality of media items (e.g., songs, videos, podcasts, etc.) in the file system 804. When a user desires to have the media player playa particular media item, a list of available media items is displayed on the display 810. Then, using the user input device 808, a user can select one of the available media items. The processor 802, upon receiving a selection of a particular media item, supplies the media data to one or more appropriate output devices. As an example, for audio output, the processor 302 can supply the media data (e.g., audio file) for the particular media item to a coder/decoder (CODEC) 812. The CODEC 812 can then produce analog output signals for a speaker 814. The speaker 814 can be a speaker internal to the media player 800 or external to the media player 800. For example, headphones or earphones that connect to the media player 800 would be considered an external speaker.

The media player 800 also includes a network/bus interface 816 that couples to a data link 818. The data link 818 allows the media player 800 to couple to another device (e.g., a host computer, a power source, or an accessory device). The data link 818 can be provided over a wired connection or a wireless connection. In the case of a wireless connection, the network/bus interface 816 can include a wireless transceiver. The data link 818 can also provide power to the media player 800 (e.g., to charge the battery 824).

U.S. Patent Publication No. 2003/0167318 A1 is hereby incorporated by reference herein. U.S. Patent Publication No. 2003/0079038 A1 is hereby incorporated by reference herein. U.S. Patent Publication No. 2006/0168351 A1 is hereby incorporated by reference herein. U.S. Patent Publication No. 2006/0100978 A1 is hereby incorporated by reference herein. U.S. Patent Publication No. 2006/0156239 A1 is hereby incorporated by reference herein. U.S. application Ser. No. 11/324,863, filed Jan. 3, 2006, and entitled “REMOTE CONTENT UPDATES FOR PORTABLE MEDIA,” is hereby incorporated herein by reference.

In one implementation, the host computer can utilize an application resident on the host computer to permit utilization and provide management for media items, including transfer and/or synchronization of media items.

The various aspects, embodiments, implementations or features of the invention can be used separately or in any combination.

The invention can be implemented by software, hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, memory cards, magnetic tape, optical data storage devices, and carrier waves. The computer readable medium can also be distributed over network-coupled computer systems so that the computer readable code is stored and executed in a distributed fashion.

The advantages of the invention are numerous. Different embodiments or implementations may yield one or more of the following advantages. It should be noted that this is not an exhaustive list of advantages and there may be other advantages which are not described herein. One advantage of the invention is that media items can be transported between different host devices by way of a portable media device. Another advantage of the invention is that those media items that are permitted to be transferred can be restricted by user requests or system policies. Still another advantage of the invention is that media items of different types can be synchronized differently, such as through use of different synchronization preferences.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method comprising:
identifying data items stored at a first device which were previously acquired by the first device from an online media server and are not stored on a second device;
identifying a portion of the data items to be sent from the first device to the second device for storage at the second device, the portion of the data items being identified based on respective software-defined storage allocation limits configured on the second device for one or more respective data item types associated with the portion of the data items; and
sending the portion of the data items from the first device to the second device for storage at the second device.

2. The method of claim 1, wherein the respective software-defined storage allocation limits configured on the second device comprise a first software-defined storage allocation limit for one of audio items, video items, or image items and a second software-defined storage allocation limit for a different one of the audio items, video items, or image items.

3. The method of claim 1, further comprising:
identifying a first unique identifier associated with the first device which designates one or more specific devices allowed to receive content from the first device for storage at the one or more specific devices;
identifying a second unique identifier associated with the second device which designates one or more specific devices allowed to send content to the second device for storage at the second device;
determining that the first unique identifier and the second unique identifier are a match;
based on the match between the first unique identifier and the second unique identifier, determining that the first device is pre-authorized to send data items to the second device for storage at the second device; and
after determining that the first device is pre-authorized to send data items to the second device, allowing the sending of the portion of the data items from the first device to the second device.

4. The method of claim 1, further comprising determining which of the data items are eligible for sending from the first device to the second device based on respective data attributes comprising at least one of resolution or a total playback time.

5. The method of claim 4, wherein identifying a portion of the data items to be sent from the first device to the second device is further based on respective media attributes comprising at least one of resolution or a total playback time.

6. The method of claim 1, further comprising:
sending, by the first device, a request for a copy of one or more data items in the portion of data items stored at the second device;
receiving, by the first device, the one or more data items from the second device; and
storing the one or more data items at the first device.

7. The method of claim 1, wherein the portion of data items comprises a first set of data items of a first data type and a second set of data items of a second data type, and wherein sending the portion of the data items from the first device to the second device comprises reducing a number of data items to be sent to the second device based on a respective software-defined storage allocation limit configured on the second device for the first data type.

8. A system comprising:
a processor; and
a computer-readable storage medium having stored therein instructions which, when executed by the processor, cause the processor to perform operations comprising:
identifying data items stored at the system which were previously acquired by the system from an online media server and are not currently stored on a particular device;
identifying a portion of the data items to be sent from the system to the particular device for storage at the particular device, the portion of the data items being identified based on respective software-defined storage allocation limits configured on the particular device for one or more respective data item types associated with the portion of the data items; and
sending the portion of the data items from the system to the particular device for storage at the particular device.

9. The system of claim 8, wherein the respective software-defined storage allocation limits configured on the particular device comprise a first software-defined storage allocation limit for one of audio items, video items, or image items and a second software-defined storage allocation limit for a different one of the audio items, video items, or image items.

10. The system of claim 8, the computer-readable storage medium storing additional instructions which, when executed by the processor, cause the processor to perform operations further comprising:
identifying a first unique identifier associated with the system which designates one or more specific devices allowed to receive content from the system for storage at the one or more specific devices;
identifying a second unique identifier associated with the particular device which designates one or more specific devices allowed to send content to the particular device for storage at the particular device;
determining that the first unique identifier and the second unique identifier are a match;
based on the match between the first unique identifier and the second unique identifier, determining that the system is pre-authorized to send data items to the particular device for storage at the particular device; and
after determining that the system is pre-authorized to send media items to the particular device, allowing the sending of the portion of the data items from the system to the particular device.

11. The system of claim 8, the computer-readable storage medium storing additional instructions which, when executed by the processor, cause the processor to perform operations further comprising determining which of the data items are eligible for sending from the system to the particular device based on respective data attributes comprising at least one of resolution or a total playback time.

12. The system of claim 11, wherein identifying a portion of the data items to be sent from the system to the particular device is further based on respective media attributes comprising at least one of resolution or a total playback time.

13. The system of claim 8, the computer-readable storage medium storing additional instructions which, when executed by the processor, cause the processor to perform operations further comprising:
sending a request for a copy of one or more data items in the portion of data items stored at the particular device;
receiving the one or more data items from the particular device; and
storing the one or more data items.

14. The system of claim 8, wherein sending the portion of the data items from the system to the particular device is performed automatically after a communication channel is established between the system and the particular device.

15. A non-transitory computer-readable medium having stored therein instructions which, when executed by a processor, cause the processor to perform operations comprising:
identifying data items stored at a first device which were previously acquired by the first device from an online media server and are not stored on a second device;
identifying a portion of the data items to be sent from the first device to the second device for storage at the second device, the portion of the data items being identified based on respective software-defined storage allocation limits configured on the second device for one or more respective data item types associated with the portion of the data items; and
sending the portion of the data items from the first device to the second device for storage at the second device.

16. The non-transitory computer-readable medium of claim 15, wherein the respective software-defined storage allocation limits configured on the second device comprise a first software-defined storage allocation limit for one of audio items, video items, or image items and a second software-defined storage allocation limit for a different one of the audio items, video items, or image items.

17. The non-transitory computer-readable medium of claim 15, storing additional instructions which, when executed by the processor, cause the processor to perform operations further comprising:
identifying a first unique identifier associated with the first device which designates one or more specific devices allowed to receive content from the first device for storage at the one or more specific devices;
identifying a second unique identifier associated with the second device which designates one or more specific devices allowed to send content to the second device for storage at the second device;
determining that the first unique identifier and the second unique identifier are a match;
based on the match between the first unique identifier and the second unique identifier, determining that the first device is pre-authorized to send data items to the second device for storage at the second device; and
after determining that the first device is pre-authorized to send data items to the second device, allowing the sending of the portion of the data items from the first device to the second device.

18. The non-transitory computer-readable medium of claim 15, storing additional instructions which, when executed by the processor, cause the processor to perform operations further comprising determining which of the data items are eligible for sending from the first device to the second device based on respective data attributes comprising at least one of resolution or a total playback time.

19. The non-transitory computer-readable medium of claim 18, wherein identifying a portion of the data items to be sent from the first device to the second device is further based on respective media attributes comprising at least one of resolution or a total playback time.

20. The non-transitory computer-readable medium of claim 15, wherein the portion of data items comprises a first set of data items of a first data type and a second set of data items of a second data type, and wherein sending the portion of the data items from the first device to the second device comprises reducing a first number of data items to be sent to the second device based on a first respective software-defined storage allocation limit configured on the second device for the first data type and reducing a second number of data items to be sent to the second device based on a second respective software-defined storage allocation limit configured on the second device for the second data type.
